(19) United States
(12) Patent Application Publication
(10) Pub. No.: US 2021/0016524 A1
(43) Pub. Date: Jan. 21, 2021

(54) METHOD FOR MANUFACTURING A COMPOSITE STRUCTURE USING A LAYUP OF NET-TRIMMED PLIES HAVING A STAGGERED EDGE STRUCTURE

(71) Applicant: The Boeing Company, Chicago, IL (US)

(72) Inventors: Zachary N. Stoddard, Mukilteo, WA (US); Ronald L. McGhee, Lynnwood, WA (US); Devin A. Good, Snohomish, WA (US); Wade A. Oswald, Mukilteo, WA (US)

(73) Assignee: The Boeing Company, Chicago, IL (US)

(21) Appl. No.: 16/513,027

(22) Filed: Jul. 16, 2019

(51) Int. Cl. B29C 70/54; B32B 3/26; B29C 70/30; B32B 27/08

(52) U.S. Cl. CPC B29C 70/545; B32B 27/08; B29C 70/30; B32B 3/263

(57) ABSTRACT

A method for manufacturing a composite structure. The method includes trimming plies of composite material to a near net-shape, thereby yielding a plurality of net-trimmed plies, wherein each net-trimmed ply of the plurality of net-trimmed plies includes an edge. The method further includes assembling a layup that includes the plurality of net-trimmed plies, wherein the assembling of the layup includes staggering the edges of the plurality of net-trimmed plies such that the edges define a staggered edge structure. The method further includes pressing the layup to form the staggered edge structure into a bevel.

### FIELD

This application relates to composite structures and, more particularly, to methods for manufacturing composite structures, such as stringers, that include a bevel along an edge thereof.

### BACKGROUND

Composite structures having bevels often find utility in a variety of applications, including in the aerospace industry. Stringers used to reinforce aircraft skin panels are an example of such a composite structure, as they include bevels formed laterally along the length of the stringer.

One current method for manufacturing composite structure with bevels generally entails forming the composite structure and then trimming away excess material to produce the bevel. However, this method is inefficient due to the wasted cost of the excess material and the time required to trim it off.

Another current method for manufacturing composite structure with bevels generally entails arranging plies of composite material in a stepwise (e.g., “pyramid”) arrangement. However, this method results in a bevel defined by exposed ply edges, which presents a vulnerability in the composite structure as the exposed edges are more susceptible to environmental damage as well as damage through use. Furthermore, small bevel angles are difficult achieve with this method.

Accordingly, those skilled in the art continue with research and development efforts in the field of manufacturing composite structures with bevels.

### SUMMARY

Disclosed are composite structures and methods for manufacturing composite structures.

In one example, the disclosed method for manufacturing a composite structure includes trimming plies of composite material to a near net-shape, thereby yielding a plurality of net-trimmed plies, wherein each net-trimmed ply of the plurality of net-trimmed plies comprises an edge. The disclosed method further includes assembling a layup that includes the plurality of net-trimmed plies, wherein the assembling of the layup includes staggering the edges of the plurality of net-trimmed plies such that the edges define a staggered edge structure. The disclosed method further includes pressing the layup to form the staggered edge structure into a bevel.

In another example, the disclosed method for manufacturing a composite structure includes cutting a bulk supply of composite material to yield a plurality of net-trimmed plies that include at least a first net-trimmed ply, a second net-trimmed ply and a third net-trimmed ply, each net-trimmed ply of the plurality of net-trimmed plies includes an edge, a length and a width, and wherein at least one of the length and the width is constant across each net-trimmed ply of the plurality of net-trimmed plies. The disclosed method further includes positioning each net-trimmed ply of the plurality of net-trimmed plies on a layup tool to yield a layup. The disclosed method further includes staggering the edges of the plurality of net-trimmed plies such that the edges define a staggered edge structure wherein the edge of the first net-trimmed ply and the edge of the third net-trimmed ply protrude outward beyond the edge of the second net-trimmed ply. The disclosed method further includes pressing the layup to form the staggered edge structure into a bevel.

In one example, the disclosed composite structure includes a plurality of net-trimmed plies, wherein each net-trimmed ply of the plurality of net-trimmed plies includes an edge. The disclosed composite structure further includes an edge portion that includes a bevel defined by at least one net-trimmed ply of the plurality of net-trimmed plies, the edge portion further includes the edges of the plurality of net-trimmed plies.

Other examples of the disclosed composite structures and methods will become apparent from the following detailed description, the accompanying drawings and the appended claims.

### BRIEF DESCRIPTION OF THE DRAWINGS

FIG. 1 is a flow diagram depicting an example of the disclosed method for manufacturing a composite structure;

FIG. 2A is a top plan view of a bulk supply of composite material;

FIG. 2B is a top plan view depicting the cutting of a net-trimmed ply from the bulk supply of composite material shown in FIG. 2A;

FIG. 3 is a front elevational view of a layup on a layup tool;

FIG. 4 is a side elevational view of the layup on the layup tool shown in FIG. 3;

FIG. 5 is a top view of a portion of the layup shown in FIG. 3;

FIG. 6 is a side view of a portion of the layup shown in FIG. 3;

FIG. 7A is a schematic illustration of the layup shown in FIG. 3 positioned between a first die and a second die;

FIG. 7B is a schematic illustration of pressing the layup shown in FIG. 3 to manufacture a composite structure that has a bevel;

FIG. 8 is a side view of a portion of the composite structure shown in FIG. 7;

FIG. 9 is an illustration of two staggered patterns;

FIG. 10 is an exploded perspective view of net-trimmed plies 30D, 30E and 30F as they have been assembled in the layup shown in FIG. 3;

FIG. 11 is a perspective view of net-trimmed plies 30G-30J as they have been assembled in the layup shown in FIG. 3;

FIG. 12 is a flow diagram depicting another example of the disclosed method for manufacturing a composite structure;

FIG. 13 is a perspective view of a stringer;

FIG. 14 is a flow diagram of an aircraft manufacturing and service methodology; and

FIG. 15 is a block diagram of an aircraft.

### DETAILED DESCRIPTION

The following detailed description refers to the accompanying drawings, which illustrate specific examples described by the disclosure. Other examples having different structures and operations do not depart from the scope of the present disclosure. Like reference numerals may refer to the same feature, element, or component in the different drawings.

Illustrative, non-exhaustive examples, which may be, but are not necessarily, claimed, of the subject matter according the present disclosure are provided below. Reference herein to “example” means that one or more feature, structure, element, component, characteristic and/or operational step described in connection with the example is included in at least one embodiment and/or implementation of the subject matter according to the present disclosure. Thus, the phrase “an example” and similar language throughout the present disclosure may, but do not necessarily, refer to the same example. Further, the subject matter characterizing any one example may, but does not necessarily, include the subject matter characterizing any other example.

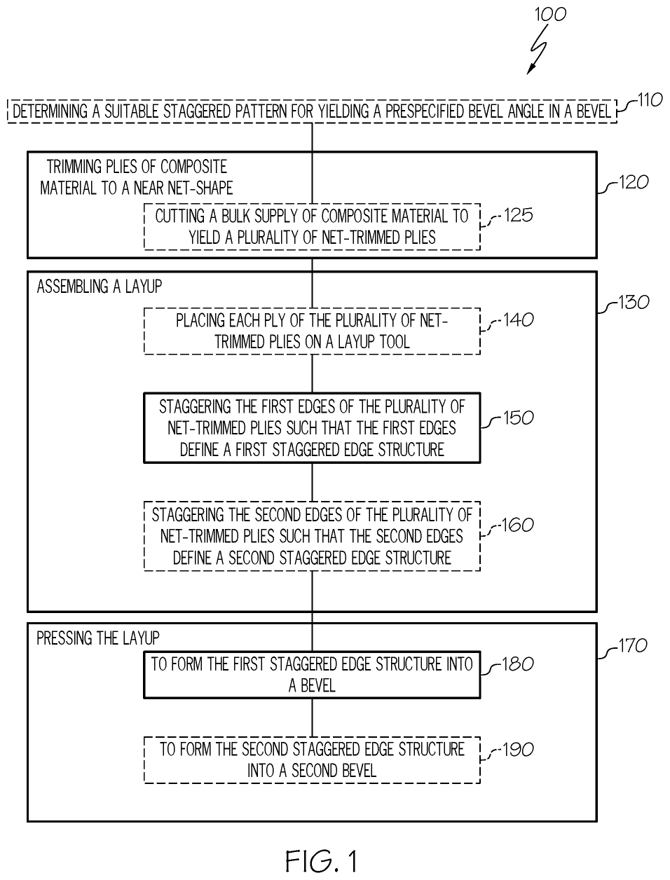

Referring to FIG. 1, one example of a method 100 for manufacturing a composite structure 10 includes trimming plies of composite material to a near net-shape (block 120), thereby yielding a plurality of net-trimmed plies 30, wherein each net-trimmed ply 30 of the plurality of net-trimmed plies 30 includes an edge 32. The method 100 further includes assembling a layup 20 that include the plurality of net-trimmed plies 30 (block 130), wherein the assembling of the layup 20 includes staggering the edges 32 of the plurality of net-trimmed plies 30 such that the edges 32 define a staggered edge structure 22 (block 150). The method 100 further includes pressing the layup 20 (block 170) to form the staggered edge structure 22 into a bevel 12 (block 180).

As used herein, “net-trimmed,” “net-trimmed plies” and “near net-shape plies” refers to plies of composite material that have been cut such that once the plies are assembled into a layup and then formed into a final composite structure, the final composite structure will require minimal, if any, finishing. The layup assembled from net-trimmed plies may be referred to as being “near net-shape” due to the layup being very close to the desired (e.g., “net”) shape of the final composite structure. Those skilled in the art will appreciate that net-trimming plies and/or assembling near net-shape layups may be preferred in many applications because post-production finishing adds undesired time and cost to the manufacturing process.

The method 100 includes trimming plies of composite material to a near net-shape (block 120), thereby yielding a plurality of net-trimmed plies 30, wherein each net-trimmed ply 30 of said plurality of net-trimmed plies 30 includes an edge 32. Each net-trimmed ply 30 of the plurality of net-trimmed plies 30 may be trimmed into varying shapes and dimensions based on, among other things, the size and/or shape of the subsequent layup 20 to be assembled, as well as the finished composite structure 10. In one example, the method 100 may include trimming the plies of composite material 50 such that each net-trimmed ply 30 of the plurality of net-trimmed plies 30 includes a length L and a width W, and that at least one of the length L and the width W is constant across each net-trimmed ply 30 of the plurality of net-trimmed plies 30. In another example, the method 100 may include trimming the plies of composite material 50 such that both the length L and the width W is constant across each net-trimmed ply 30 of the net-trimmed plurality of plies 30. In yet another example, the method 100 may include trimming the plies of composite material 50 such that each net-trimmed ply 30 of the plurality of net-trimmed plies 30 is substantially rectangular. Those skilled in the art will appreciate that net-trimmed plies 30 may be trimmed into non-rectangular shapes, non-polygonal shapes, and even irregular shapes without departing from the scope of the present disclosure. Those skilled in the art will also appreciate, however, that rectangular net-trimmed plies having straight edges will typically be faster and cheaper to produce, due to the simplicity of the shape.

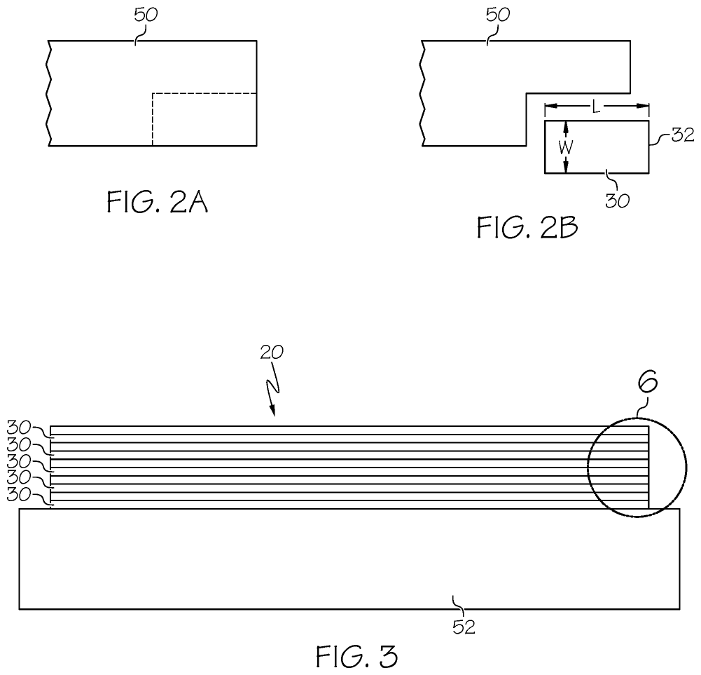

Referring to FIGS. 2A and 2B, the trimming of the plies of composite material (block 120) may include cutting a bulk supply of composite material 50 to yield the plurality of net-trimmed plies 30 (block 125). The bulk supply of composite material 50 may be, for example, a bulk roll, an in-house extrusion system, or various other systems configured to provide a continuous supply of composite material from which net-trimmed plies may be cut.

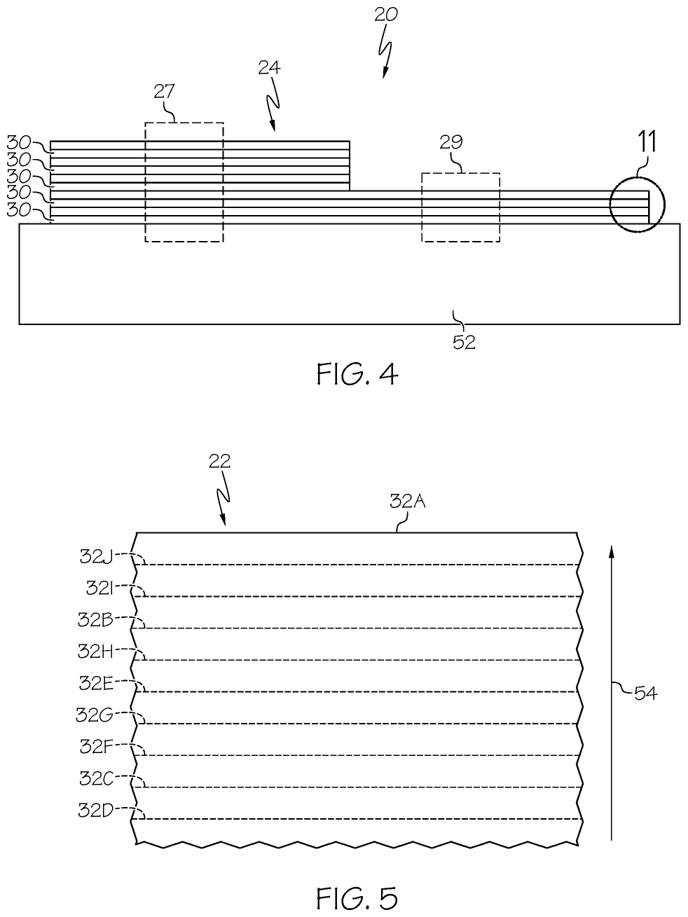

Once a plurality of net-trimmed plies 30 has been obtained, the assembling of the layup (block 130) may further include placing each net-trimmed ply 30 of the plurality of net-trimmed plies 30 on a layup tool 52 (block 140). The layup tool 52 may include any structure with a suitable surface upon which a layup may be assembled, such as a die or a mold. Those skilled in the art will appreciate that the actual surface upon which the plurality of net-trimmed plies 30 is to be placed may vary in shape (e.g., planar or contoured) without departing from the scope of the present disclosure. This step (block 140) may be performed, for example, by stacking net-trimmed plies 30 on top of one another to yield the layup 20 shown in FIGS. 3 and 4.

Upon placement (block 140), the position of each net-trimmed ply 30 relative to other net-trimmed plies 30 of the plurality of net-trimmed 30 plies may vary. As shown in FIG. 5, each net-trimmed ply 30 of the plurality of net-trimmed plies 30 may be generally positioned such that their edges 32 are substantially parallel to one another and protrude outward in the same protruding direction 54. However, depending on factors such as the size and shape of each individual net-trimmed ply 30 of the plurality of net-trimmed plies 30, it is also contemplated that the edges 32 of the plurality of net-trimmed plies 30 may be arranged such that they are non-parallel (not shown). Further, the size and shape of the layup 20 to be assembled is determined at least in part by the size and shape of each individual net-trimmed ply 30. As shown in FIG. 4, some net-trimmed plies 30 of the plurality of net trimmed plies 30 may be shorter than others and, as a result, the shorter net-trimmed plies 30 may define a raised feature 24 on top of the longer net-trimmed plies 30. As a result, the layup 20 may include a first portion 27 and a second portion 29, wherein the first portion 27 includes more net-trimmed plies 30 of the plurality of net-trimmed plies 30 than the second portion 29. Those skilled in the art will appreciate that other arrangements of net-trimmed plies 30 based on the size and shape of each individual net-trimmed ply 30 may be employed without departing from the scope of the present disclosure. It is generally contemplated, however, that the assembling of the layup (block 120) would include assembling a layup having a near net-shape.

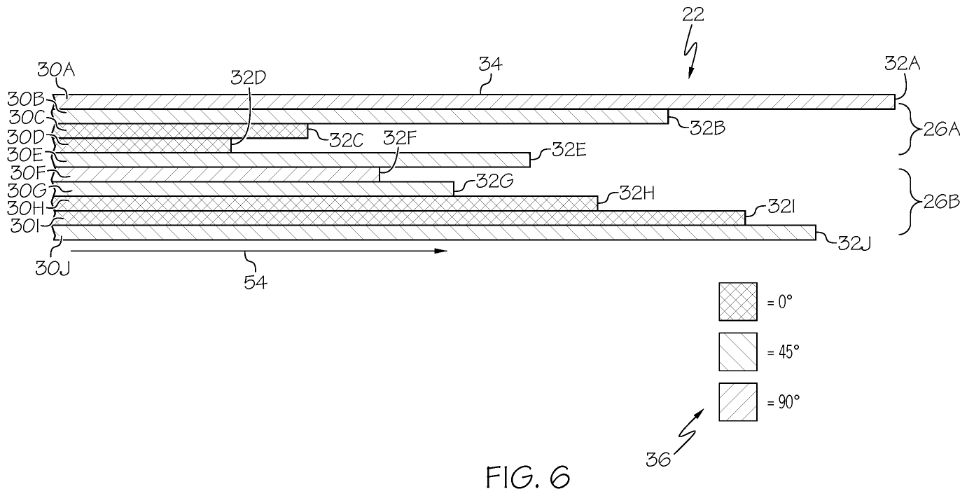

Referring to FIG. 6, each net-trimmed ply 30 of the plurality of net-trimmed plies 30 includes, among other things, an edge 32. The assembling of the layup (block 130) includes staggering these edges 32 such that the edges 32 define a staggered edge structure 22 in the layup 20 (block 150). More specifically, each net-trimmed ply 30 of the plurality of net-trimmed plies 30 is positioned such that the edges 32 of these net-trimmed plies 30 protrude outward to varying extents, thereby being “staggered.” Further, the degree to which any particular edge 32 protrudes is dependent on the size of the net-trimmed ply 30 to which that edge 32 belongs, as well as the position of that net-trimmed ply 30 relative to the other net-trimmed plies 30 of the plurality of net-trimmed plies 30. The staggering of the edges (block 150) may be performed either simultaneously with the placing of the plurality of net-trimmed plies (block 140) or after all the net-trimmed plies 30 have been placed.

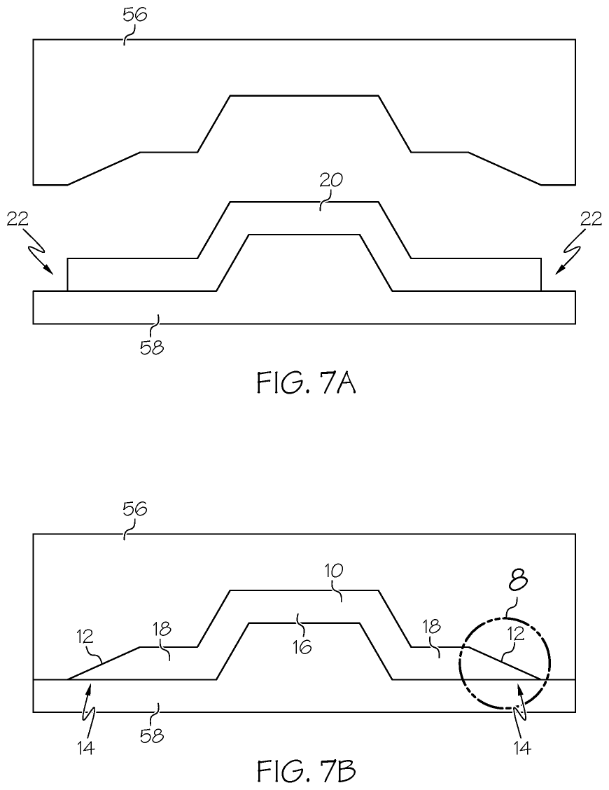

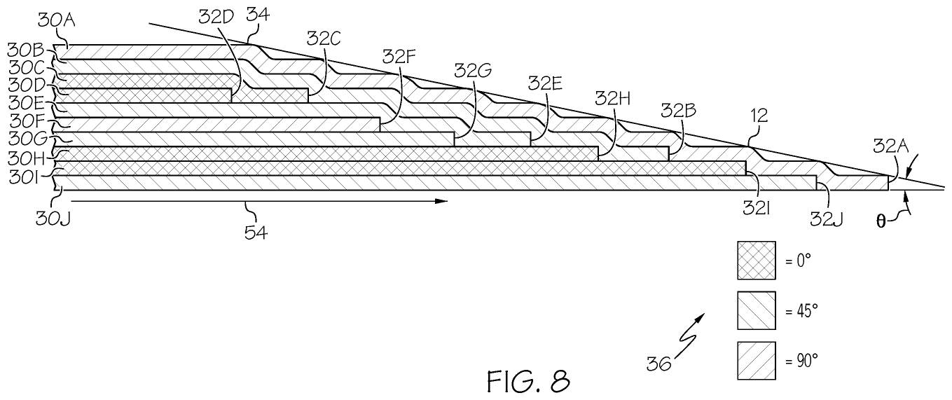

Referring to FIGS. 7A, 7B and 8, after a layup 20 having a staggered edge structure 22 has been assembled (block 130), the layup 20 may then be pressed (block 170) to form the staggered edge structure 22 into a bevel 12 (block 180). More specifically, as the layup 20 is being pressed, the staggered edge structure 22 mechanically deforms inward, thereby causing some net-trimmed plies 30 of the plurality of net-trimmed plies 30 to fold over the edges 32 of other net-trimmed plies 30. In effect, the staggered edge structure 22 begins to taper in the protruding direction 54, thereby resulting in a bevel 12.

The pressing of the layup (block 170) may be performed by any suitable means, such as by positioning the layup 20 between a first die 56 and a second die 58, and then approximating the first die 56 and the second die 58 to press the layup 20. Those skilled in the art will appreciate that other processing conditions related to the pressing, such as the degree of compressive force and/or the compression time, may vary without departing from the scope of the present disclosure.

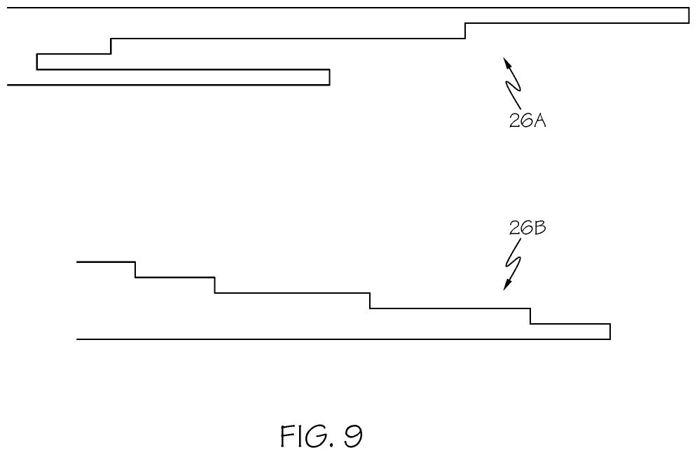

Referring to FIG. 9, a staggered edge structure 22 may include at least one staggered pattern 26. The phrase “staggered pattern” refers simply to an arrangement of two or more net-trimmed plies 30, wherein the arrangement includes the positions of the edges 32 of those net-trimmed plies 30. The assembling of the layup (block 130) may include staggering the edges 32 of the plurality of net-trimmed plies 30 such that the staggered edge structure 22 of the layup 20 includes at least one staggered pattern 26A, 26B. Staggered patterns 26 may be considered along with other processing conditions, such as the material composition of the net-trimmed plies 30 and/or the shape of the tools used to press the layup 20, in order to achieve a certain shape in the finished composite structure 10. For example, the method 100 may include determining a suitable staggered pattern 26 for yielding a prespecified bevel angle θ in the bevel 12 of a finished composite structure 10 (block 110). This determining step (block 110) may be performed at any time prior to when the edges 32 of the plurality of net-trimmed plies 30 are being staggered (block 150). In one example, the method 100 may include determining a suitable staggered pattern 26 for yielding a prespecified bevel angle θ of about 5° in the bevel 12. In another example, the method 100 may include determining a suitable staggered pattern 26 for yielding a prespecified bevel angle θ of about 10° in the bevel 12. In another example, the method 100 may include determining a suitable staggered pattern 26 for yielding a prespecified bevel angle θ of about 15° in the bevel 12. Those skilled in the art will appreciate, however, that staggered patterns 26 suitable for yielding other shapes, such as curved (e.g., non-linear) surfaces, or for yielding different bevel angles θ may be employed without departing from the scope of the present disclosure.

Referring back to FIG. 6, in one or more examples, the plurality of net-trimmed plies 30 may include a first net-trimmed ply 30C having a first edge 32C, a second net-trimmed ply 30D having a second edge 32D, and a third net-trimmed ply 30E having a third edge 32E. In these examples, the assembling of the layup (block 130) may include positioning the second ply 30D between the first ply 30C and the third ply 30E, and staggering both the first edge 32C and the third edge 32E relative to the second edge 32D such that the first edge 32C and the third edge 32E protrude outward beyond the second edge 32D. The resulting layup 20 would include a staggered edge structure 22 not characterized by a stepwise (e.g., “pyramid”) arrangement. Pressing the layup 20, in these examples, may enable at least one of the first ply 30C and the third ply 30E may fold over the second edge 32D.

Those skilled in the art will appreciate, however, that the staggered edge structure 22 in any given example may include multiple instances wherein a superjacent net-trimmed ply 30B and a subjacent net-trimmed ply 30I have edges 32B, 32I that protrude outward beyond the edge 32F of a net-trimmed ply 30F positioned between them, even if there are additional net-trimmed plies 30C-30E, 30G-30H positioned between the superjacent net-trimmed ply 30B and the subjacent net-trimmed ply 30I.

Still referring to FIG. 6, in one example, the plurality of net-trimmed plies 30 may include a first exterior net-trimmed ply 30A opposed from a second exterior net-trimmed ply 30J. In this example, the assembling of the layup (block 130) may include positioning the first exterior net-trimmed ply 30A opposed from the second exterior net-trimmed ply 30J, and every other net-trimmed ply 30B-301 of the plurality of net-trimmed plies 30 between the first exterior net-trimmed ply 30A and the second exterior net-trimmed ply 30J. The assembling (block 130) may further include staggering the edge 32A of the first exterior net-trimmed ply 30A relative to every other edge 32B-32J of the plurality net-trimmed plies 30 such that the edge 32A of the first exterior net-trimmed ply 30A protrudes outward beyond every other edge 32B-32J of the plurality of net-trimmed plies 30. At this point, those skilled in the art will appreciate that in pressing the layup 20 of this example, the first exterior net-trimmed ply 30A may fold over at least some, if not all, of the edges 32B-32J of the other net-trimmed plies 30B-30J of the plurality of net-trimmed plies 30 (FIG. 8). As a result, the exposed side 34 of the first exterior net-trimmed ply 30A (e.g., the side not in contact with another net-trimmed ply) may thereby define a bevel 12 in the finished composite structure 10. Those skilled in the art will also appreciate that it may be preferable in some applications for the first exterior net-trimmed ply 30A to fold over all the edges 32B-32J of the other net-trimmed plies 30B-30J, as opposed to only some of those edges 32B-32J, because the resulting composite structure 10 will have less exposed edges 32 and a smoother, more continuous bevel 12.

In another example, the assembling of the layup (block 130) may further include staggering the edge 32J of the second exterior net-trimmed ply 30J relative to every other edge 32A-32I of the plurality of net-trimmed pies 30 such that the edge 32J of the second exterior net-trimmed ply 30J protrudes outward beyond every other edge 32A-32I of the plurality of net-trimmed plies 30 except for the edge 32A of the first exterior net-trimmed ply 30A. At this point, those skilled in the art will appreciate that upon pressing the layup 20 in this example, at least one of the first exterior net-trimmed ply 30A and the second exterior net-trimmed ply 30J may fold over at least some, if not all, of the edges 32B-32I of the other net-trimmed plies 30B-301 of the plurality of net-trimmed plies 30. As shown in FIG. 8, the first exterior net-trimmed ply 30A and the second exterior net-trimmed ply 30J is folded over all the edges 32B-32I of the net-trimmed plies 30B-301 positioned between them.

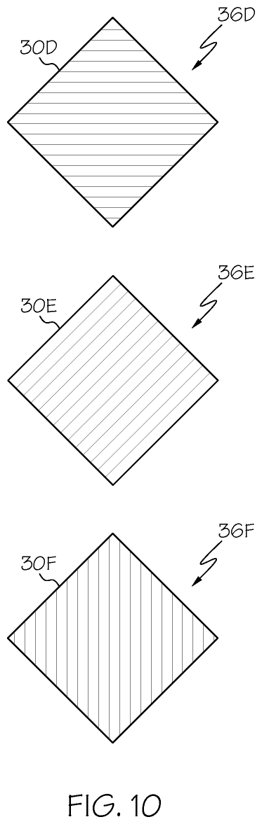

The plurality of net-trimmed plies 30 may include net-trimmed plies 30 having various fiber orientations 36. For example, the plurality of net-trimmed plies 30 may include net-trimmed plies 30 having a first fiber orientation 36D, net-trimmed plies 30 having a second fiber orientation 36E, and net-trimmed plies 30 having a third fiber orientation 36F. As shown in FIGS. 6, 8 and 10, the first fiber orientation 36D may be about 0°, the second fiber orientation 36E may be about 45°, and the third fiber orientation 36F may be about 90°. Further, the assembling of the layup (block 130) may include alternating net-trimmed plies 30 based on fiber orientation 36. In one example, a first net-trimmed ply 30D may be positioned relative to a second net-trimmed ply 30E such that the fiber orientation 36E of the second net-trimmed ply 30E is offset relative to the fiber orientation 36D of the first net-trimmed ply 30D by about 45°. In another example, a first net-trimmed ply 30D may be positioned relative to a second net-trimmed ply 30F such that the fiber orientation 36F of the second net-trimmed ply 30F is offset relative to the fiber orientation 36D of the first net-trimmed ply 30D by about 90°. Those skilled in the art will appreciate, however, that different offset angles and either more or less fiber orientations 36 may be employed without departing from the scope of the present disclosure.

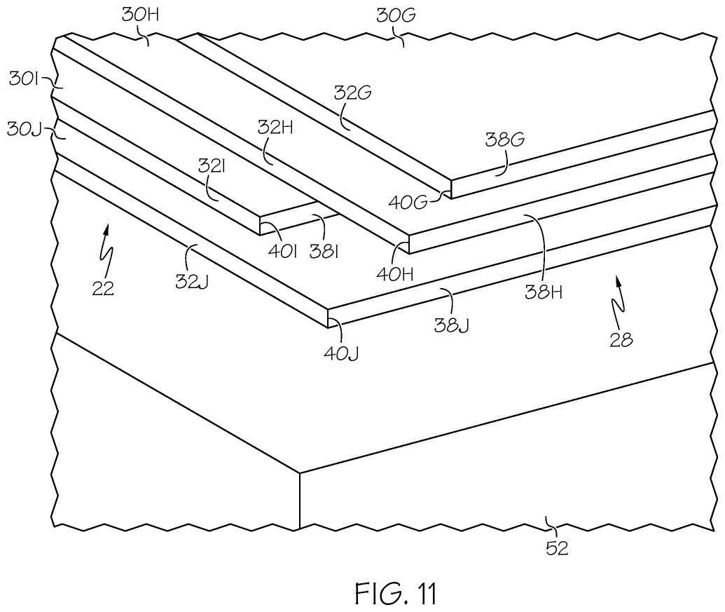

Referring to FIG. 11, in one example, each net-trimmed ply 30 of the plurality of net-trimmed plies 30 may include a first edge 32 and a second edge 38 that defines a corner 40 with the first edge 32. In this example, the assembling of the layup (block 130) may include staggering the first and second edges (blocks 150 and 160) of the plurality of net-trimmed plies 30 such that the first edges 32 define a first staggered edge structure 22 and the second edges 38 define a second staggered edge structure 28. Further, upon pressing the layup 20, the first staggered edge structure 22 may be formed into a first bevel 12 and the second staggered edge structure 28 may define a second bevel (not shown). In some examples, the first bevel 12 may also define a corner with the second bevel. Those skilled in the art will appreciate, however, that each net-trimmed ply 30 of the plurality of net-trimmed plies 30 may also include additional (e.g., more than two) edges from which additional staggered edge structures may be defined, without departing from the scope of the present disclosure. Therefore, it is contemplated that composite structures having more than two bevels may be manufactured using the method of the present disclosure.

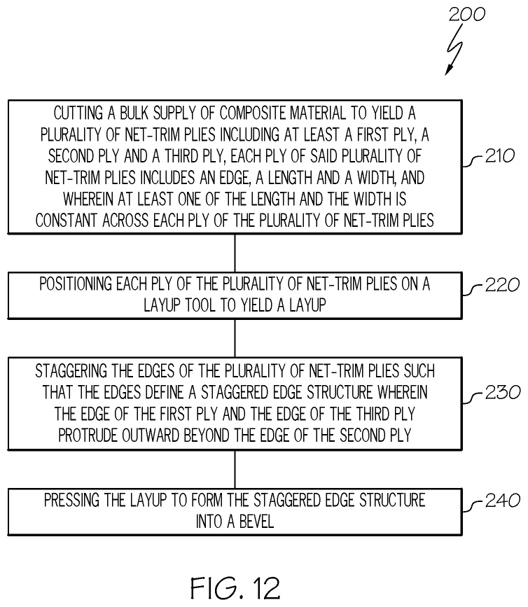

Referring to FIG. 12, the present disclosure provides another example of a method 200 for manufacturing a composite structure 10. This method 200 includes cutting a bulk supply of composite material 50 to yield a plurality of net-trimmed plies 30 (block 210), wherein the plurality of net-trimmed plies 30 includes at least a first net-trimmed ply 30A, a second net-trimmed ply 30D and a third net-trimmed ply 30J, and wherein each net-trimmed ply 30 of the plurality of net-trimmed plies 30 includes an edge 32, a length L and a width W, and wherein at least one of the length L and the width W is constant across each net-trimmed ply 30 of the plurality of net-trimmed plies 30. The method 200 also includes positioning each net-trimmed ply 30 of the plurality of net-trimmed plies 30 on a layup tool 52 to yield a layup 20 (block 220), and staggering the edges 32 of the plurality of net-trimmed plies 30 such that the edges 32 define a staggered edge structure 33 wherein the edge 32A of the first net-trimmed ply 30A and the edge 32J of the third net-trimmed ply 30J protrude outward beyond the edge 32D of the second net-trimmed ply 30D. The method 200 further includes pressing the layup 20 to form the staggered edge structure 22 into a bevel 12 (block 240).

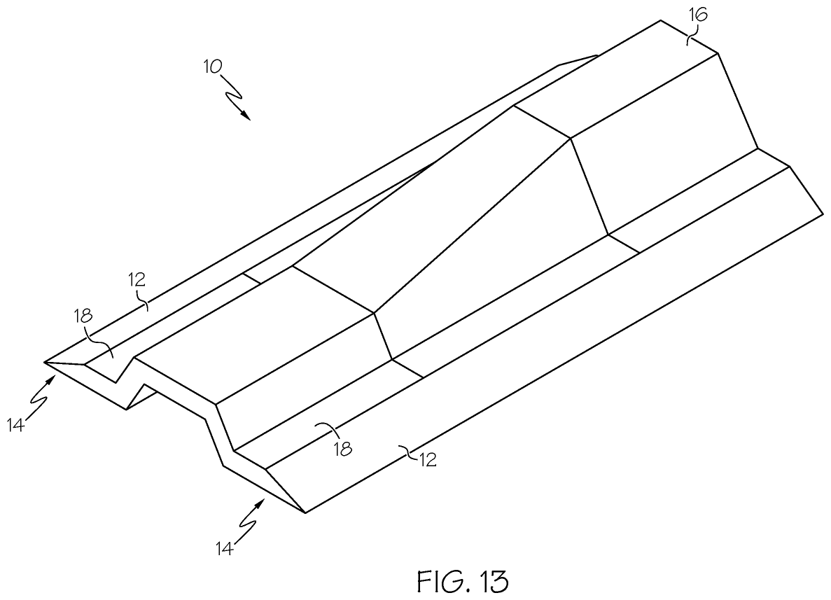

Referring to FIG. 13, the present disclosure provides an example of a composite structure 10. The composite structure 10 includes a plurality of net-trimmed plies 30, wherein each net-trimmed ply 30 of the plurality of net-trimmed plies 30 includes an edge 32. The composite structure 10 also includes an edge portion 14 that includes the edges 32 of the plurality of net-trimmed plies 30, as well as a bevel 12 defined by at least one net-trimmed ply 30 of the plurality of net-trimmed plies 30. As shown, the composite structure may be a stringer that includes a web portion 16 and a flange 18 proximate the web portion 16, wherein the flange 18 includes the edge portion 14. Those skilled in the art will appreciate, however, that the composite structure 10 of the present disclosure may be any conceivable composite structure that has a bevel, regardless of the end-use application.

Each net-trimmed ply 30 of the plurality of net-trimmed plies 30 of the composite structure 10 may vary in shape. In one example, each net-trimmed ply 30 of the plurality of net-trimmed plies 30 may include a length L and a width W, wherein at least one of the length L and the width W is constant across each net-trimmed ply 30 of the plurality of net-trimmed plies 30. In another example, both the length L and the width W may be constant across each net-trimmed ply 30 of the plurality of net-trimmed plies 30. In yet another example, each net-trimmed ply 30 of the plurality of net-trimmed plies 30 may be substantially rectangular.

Within the edge portion 14 of the composite structure 10, the position of any given edge 32 of the plurality of net-trimmed plies 30 relative to the other edges 32 may vary. In one or more examples, the edges 32 may be substantially parallel to one another. In other examples, the edges 32 may be rotationally offset either due to the way the net-trimmed plies 30 were placed or due to the shapes of the net-trimmed plies 30 to which the edges 32 belong. Further, the positions of any given edge 32 of the plurality of net-trimmed plies 30 may also vary in terms of the degree to which they protrude outward in a protruding direction 54. Where the edges 32 protrude outward to non-uniform extents, the edges 32 may be considered “staggered.”

In one example, the plurality of net-trimmed plies 30 may include a first net-trimmed ply 30B having a first edge 32B, a second net-trimmed ply 30E having a second edge 32E, and a third net-trimmed ply 30H having a third edge 32H. In this example, the first and third plies 30B, 30H may be positioned relative to the second ply 30E such that the first edge 32B and the third edge 32H may protrude outward beyond the second edge 32E.

In another example, the plurality of net-trimmed plies 30 may include a first exterior net-trimmed ply 30A and a second exterior net-trimmed ply 30J, and every other net-trimmed ply 30B-301 of the plurality of net-trimmed plies 30 may be positioned the first exterior net-trimmed ply 30A and the second exterior net-trimmed ply 30J. In this example, the edge 32A of the first exterior net-trimmed ply 30A may protrude outward beyond every other edge 32B-32J of the plurality of net-trimmed plies 30. Further, the first exterior net-trimmed ply 30A may be folded over at least some, if not all, of the edges 32B-32J of the other net-trimmed plies 30B-30J of the plurality of net-trimmed plies 30.

In yet another example, the plurality of net-trimmed plies 30 may include a first exterior net-trimmed ply 30A and a second exterior net-trimmed ply 30J, and every other net-trimmed ply 30B-301 of the plurality of net-trimmed plies 30 may be positioned the first exterior net-trimmed ply 30A and the second exterior net-trimmed ply 30J. In this example, the edge 32J of the second exterior net-trimmed ply 30J may protrude outward beyond every other edge 32A-32I of the plurality of net-trimmed plies 30 except for the edge 32A of the first exterior net-trimmed ply 30A. As such, at least one of the first exterior net-trimmed ply 30A and the second exterior net-trimmed ply 30J may be folded over at least some, if not all, of the edges 32B-32I of the other net-trimmed plies 30B-301 of the plurality of net-trimmed plies 30.

The plurality of net-trimmed plies 30 may also include net-trimmed plies 30 having various fiber orientations 36. These net-trimmed plies 30 may be positioned relative to one another such that their fiber orientations 36 are offset. In one example, the plurality of net-trimmed plies 30 includes a first net-trimmed ply 30C having a first fiber orientation 36C and a second net-trimmed ply 30F, 30G having a second fiber orientation 36F, 36G. In this example, the second fiber orientation 36G may be offset relative to the first fiber orientation 36C by about 45°. In another example, the second fiber orientation 36F may be offset relative to the first fiber orientation 36C by about 90°. Those skilled in the art will appreciate that other offset angles may be employed without departing from the scope of the present disclosure.

The bevel 12 formed in the edge portion 14 of the composite structure 10 may define a bevel angle θ. In one example, the bevel angle θ may be about 5°. In another example, the bevel angle θ may be about 10°. In yet another example, the bevel angle θ may be about 15°. Those skilled in the art will appreciate that the bevel 12 may define various other bevel angles θ without departing from the scope of the present disclosure.

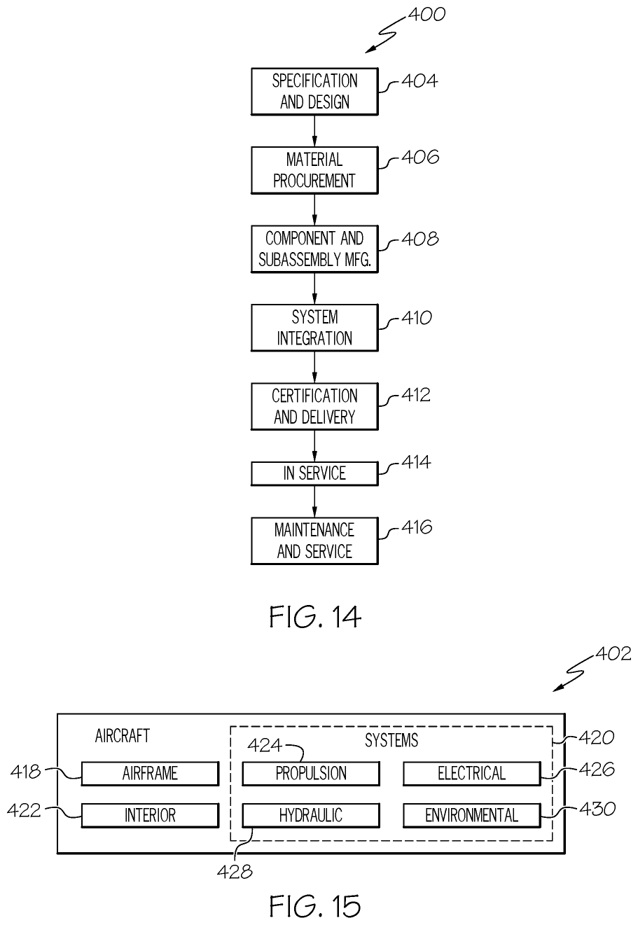

Examples of the disclosure may be described in the context of an aircraft manufacturing and service method 400, as shown in FIG. 14, and an aircraft 402, as shown in FIG. 15. During pre-production, the aircraft manufacturing and service method 400 may include specification and design 404 of the aircraft 402 and material procurement 406. During production, component/subassembly manufacturing 408 and system integration 410 of the aircraft 402 takes place. Thereafter, the aircraft 402 may go through certification and delivery 412 in order to be placed in service 414. While in service by a customer, the aircraft 402 is scheduled for routine maintenance and service 416, which may also include modification, reconfiguration, refurbishment and the like.

Each of the processes of method 400 may be performed or carried out by a system integrator, a third party, and/or an operator (e.g., a customer). For the purposes of this description, a system integrator may include without limitation any number of aircraft manufacturers and major-system subcontractors; a third party may include without limitation any number of venders, subcontractors, and suppliers; and an operator may be an airline, leasing company, military entity, service organization, and so on.

As shown in FIG. 15, the aircraft 402 produced by example method 400 may include an airframe 418 with a plurality of systems 420 and an interior 422. Examples of the plurality of systems 420 may include one or more of a propulsion system 424, an electrical system 426, a hydraulic system 428, and an environmental system 430. Any number of other systems may be included.

The disclosed composite structure and method for manufacturing a composite structure may be employed during any one or more of the stages of the aircraft manufacturing and service method 400. As one example, the disclosed composite structure and method for manufacturing a composite structure may be employed during material procurement 406. As another example, components or subassemblies corresponding to component/subassembly manufacturing 408, system integration 410, and or maintenance and service 416 may be fabricated or manufactured using the disclosed composite structure and method for manufacturing a composite structure. As another example, the airframe 418 and the interior 422 may be constructed using the disclosed composite structure and method for manufacturing a composite structure. Also, one or more apparatus examples, method examples, or a combination thereof may be utilized during component/subassembly manufacturing 408 and/or system integration 410, for example, by substantially expediting assembly of or reducing the cost of an aircraft 402, such as the airframe 418 and/or the interior 422. Similarly, one or more of system examples, method examples, or a combination thereof may be utilized while the aircraft 402 is in service, for example and without limitation, to maintenance and service 416.

The disclosed composite structure and method for manufacturing a composite structure are described in the context of an aircraft; however, one of ordinary skill in the art will readily recognize that the disclosed composite structure and method for manufacturing a composite structure may be utilized for a variety of applications. For example, the disclosed composite structure and method for manufacturing a composite structure may be implemented in various types of vehicles including, e.g., helicopters, passenger ships, automobiles and the like.

Although various examples of the disclosed composite structure and method for manufacturing a composite structure have been shown and described, modifications may occur to those skilled in the art upon reading the specification. The present application includes such modifications and is limited only by the scope of the claims.

1. A method for manufacturing a composite structure comprising:
trimming plies of composite material to a near net-shape, thereby yielding a plurality of net-trimmed plies, wherein each net-trimmed ply of said plurality of net-trimmed plies comprising an edge;
assembling a layup comprising said plurality of net-trimmed plies, wherein said assembling said layup comprises staggering said edges of said plurality of net-trimmed plies such that said edges define a staggered edge structure; and
pressing said layup to form said staggered edge structure into a bevel.

2. The method of claim 1 wherein:
said plurality of net-trimmed plies comprises a first exterior net-trimmed ply opposed from a second exterior net-trimmed ply;
said assembling comprises positioning said first exterior net-trimmed ply opposed from said second exterior net-trimmed ply and every other net-trimmed ply of said plurality of net-trimmed plies between said first exterior net-trimmed ply and said second exterior net-trimmed ply; and
said assembling further comprises staggering said edge of said first exterior net-trimmed ply relative to every other edge of said plurality of net-trimmed plies such that said edge of said first exterior net-trimmed ply protrudes outward beyond every other edge of said plurality of net-trimmed plies.

3. The method of claim 2 wherein said assembling further comprises staggering said edge of said second exterior net-trimmed ply relative to every other edge of said plurality of net-trimmed plies such that said edge of said second exterior net-trimmed ply protrudes outward beyond every other edge of said plurality of net-trimmed plies except for said edge of said first exterior net-trimmed ply.

4. The method of claim 2 wherein said pressing comprises pressing said layup such that said first exterior net-trimmed ply folds over at least some of said edges of said plurality of net-trimmed plies.

5. The method of claim 2 wherein said pressing comprises pressing said layup such that said first exterior net-trimmed ply folds over every edge of said plurality of net-trimmed plies except for said edge of said first exterior net-trimmed ply.

6. The method of claim 1 wherein:
each ply of said plurality of net-trimmed plies comprises said edge, which is a first edge, and further comprises a second edge that defines a corner with said first edge;
said assembling said layup further comprises staggering said second edges of said plurality of net-trimmed plies such that said second edges define a second staggered edge structure; and
said pressing said layup further comprises pressing said layup to form at least a portion of said second staggered edge structure into a second bevel.

7. The method of claim 1 wherein said assembling said layup comprises assembling a layup that comprises a first portion and a second portion, wherein said first portion comprises more plies of said plurality of net-trimmed plies than said second portion.

8. The method of claim 1 wherein said staggered edge structure comprises a staggered pattern, and wherein said assembling comprises staggering said edges of said plurality of net-trimmed plies such that said staggered edge structure of said layup comprises said staggered pattern.

9. The method of claim 8 further comprising determining a suitable staggered pattern for yielding a prespecified bevel angle in said bevel.

10. (canceled)

11. The method of claim 1 wherein said trimming comprises cutting a bulk supply of composite material to yield said plurality of net-trimmed plies.

12. The method of claim 1 wherein said trimming comprises trimming said plies of composite material such that each net-trimmed ply of said plurality of net-trimmed plies is substantially rectangular.

13. The method of claim 1 wherein said trimming comprises trimming said plies of composite material such that each net-trimmed ply of said plurality of net-trimmed plies comprises a length and a width, and at least one of said length and said width is constant across each net-trimmed ply of said plurality of net-trimmed plies.

14. The method of claim 13 wherein both of said length and said width are constant across each net-trimmed ply of said plurality of net-trimmed plies.

15. (canceled)

16. The method of claim 1 wherein said assembling said layup comprises assembling a layup having a near net-shape.

17. The method of claim 1 wherein said assembling comprises positioning each net-trimmed ply of said plurality of net-trimmed plies such that said edges of said plurality of net-trimmed plies are substantially parallel to one another.

18. The method of claim 1 wherein:
said plurality of net-trimmed plies comprises:
a first net-trimmed ply comprising a first edge;
a second net-trimmed ply comprising a second edge;
a third net-trimmed ply comprising a third edge;
said assembling comprises positioning said second net-trimmed ply between said first net-trimmed ply and said third net-trimmed ply; and
said assembling further comprises staggering said first edge and said third edge relative to said second edge such that said first edge and said third edge protrude outward beyond said second edge.

19. The method of claim 1 wherein said plurality of net-trimmed plies comprises a first net-trimmed ply comprising a first fiber orientation and a second net-trimmed ply comprising a second fiber orientation, and wherein said assembling comprises positioning said first net-trimmed ply relative to said second net-trimmed ply such that said second fiber orientation is offset relative to said first fiber orientation.

20-21. (canceled)

22. The method of claim 1 wherein said pressing comprises:
positioning said layup between a first die and a second die; and
approximating said first die and said second die to press said layup.

23. A method for manufacturing a composite structure comprising:
trimming plies of composite material to a near net-shape, thereby yielding a plurality of net-trimmed plies comprising at least a first net-trimmed ply, a second net-trimmed ply and a third net-trimmed ply, wherein each net-trimmed ply of said plurality of net-trimmed plies comprises an edge;
positioning each net-trimmed ply of said plurality of net-trimmed plies on a layup tool to yield a layup;
staggering said edges of said plurality of net-trimmed plies such that said edges define a staggered edge structure wherein said edge of said first net-trimmed ply and said edge of said third net-trimmed ply protrude outward beyond said edge of said second net-trimmed ply; and
pressing said layup to form said staggered edge structure into a bevel.

24. A composite structure comprising:
a plurality of net-trimmed plies, wherein each net-trimmed ply of said plurality of net-trimmed plies comprises an edge; and
an edge portion comprising a bevel defined by at least one net-trimmed ply of said plurality of net-trimmed plies, said edge portion further comprising said edges of said plurality of net-trimmed plies.

25-37. (canceled)
